(19) United States
(12) Patent Application Publication
(10) Pub. No.: US 2015/0068657 A1
(43) Pub. Date: Mar. 12, 2015

(54) FUNCTIONAL PULP-CONTAINING COMPOSITES FOR DRYWALL APPLICATIONS

(71) Applicant: Soane Labs, LLC, Cambridge, MA (US)

(72) Inventors: Gangadhar Jogikalmath, Cambridge, MA (US); David S. Soane, Chestnut Hill, MA (US)

(73) Assignee: Soane Labs, LLC, Cambridge, MA (US)

(21) Appl. No.: 14/289,764

(22) Filed: May 29, 2014

Related U.S. Application Data
(63) Continuation of application No. PCT/US12/66615, filed on Nov. 27, 2012.
(60) Provisional application No. 61/564,643, filed on Nov. 29, 2011.

(51) Int. Cl. D21H 21/36; D21H 17/35; D21H 17/55; B28B 1/30

(52) U.S. Cl. CPC D21H 21/36; B28B 1/30; D21H 17/35; D21H 17/55
USPC 156/41; 156/39; 156/42; 162/163; 162/159; 162/161

(57) ABSTRACT

The present invention provides composite materials comprising a population of cellulose fibers complexed with an activator, and an additive comprising synthetic fibers complexed with a tethering agent, wherein the tethering agent has an affinity for the activator, and wherein an interaction between the tethering agent and the activator attaches the synthetic fibers to the cellulose fibers to form the composite material. The present invention also provides methods of manufacture for such composite materials, and methods for their use, for example in forming gypsum board composites.

### RELATED APPLICATIONS

This application is a continuation of International Application No. PCT/US12/66615, which designated the United States and was filed on Nov. 27, 2012, published in English, which claims the benefit of U.S. Provisional Application Ser. No. 61/564,643, filed Nov. 29, 2011. The entire contents of the above-referenced applications are incorporated by reference herein.

### FIELD OF THE APPLICATION

This application relates generally to making specialized paper products for drywall applications.

### BACKGROUND

Construction drywalls are typically made by sandwiching a gypsum core between two paper plies. The paper layer holds the gypsum board together during the setting and drying processes, and it allows the surface to accept paint and display a smooth exterior finish. In the finished gypsum product, the two layers of paper provide tensile strength that allows the material to be handled, installed and used for vertical paneling. While paper facing material is inexpensive and convenient to handle, it is vulnerable to moisture degradation, mold formation and fire.

Upon exposure to moisture, either through direct contact with water or due to a high humidity environment, the paper facing can degrade or delaminate, compromising its mechanical strength and integrity. Paper-faced gypsum board is thus not suitable for those building uses where moisture exposure is anticipated. In addition, moisture (either through direct exposure or high humidity) facilitates the growth of mold in the paper facing. The cellulosic content of the paper facing material provides a nutrient environment for microbial growth such as mold and mildew. It is now recognized that health issues can arise from mold or mildew in buildings. Treating the paper surfaces with chemical agents like fungicides can counteract mold growth, but these treatments introduce their own health and environmental concerns. An additional drawback to the paper surface is its vulnerability to fire. The paper facing of drywall quickly burns when exposed to fire. Although the mineral gypsum core is not itself flammable, drywall derives much of its mechanical strength from its facing layers; once the facing is destroyed, the mechanical strength is impaired. Thus, exposure to fire can affect the strength of the drywall, allowing it to collapse away from the underlying structural framing so that the fire can spread.

Alternatives to paper facing for gypsum have been devised. Fibrous mats, for example using non-woven glass fibers, can be applied to the gypsum core instead of paper. Such technologies are more expensive than kraft paper facing, however, and they introduce other problems in handling and surface finishing. A fiberglass mat, for example, can irritate the skin and cause respiratory problems which are thought to be caused by the release of glass fibers during handling or cutting. Workers thus may need to wear protective garments and breathing masks on the jobsite, which can be uncomfortable and hot. Alternatives to fiberglass, such as polymeric fibers, are more expensive and still cause exposure problems, especially during cutting. In addition, these non-paper surfaces do not guarantee resistance to moisture, mold or fire. Furthermore, the fibers in the facing surface produce irregularities that make painting difficult and that result in unsatisfactory finished aesthetics. In many cases, an additional surface treatment (e.g., skim coating with a drywall joint compound and then sanding) is necessary to allow the drywall to accept paint adequately and yield a smooth finished appearance. These additional steps add to the expense of the process and produce more dust.

The use of paper for gypsum facing has cost and handling advantages, though it allows moisture to penetrate, mold to grow, and fire to spread. There remains a need in the art to produce a gypsum facing material that provides resistance to moisture, mold and fire, without introducing additional expense and without requiring cumbersome protective measures for workers.

### BRIEF DESCRIPTION OF THE FIGURES

FIG. 1 shows a graph of normalized load for a set of samples.

FIG. 2 shows a graph of normalized load for a set of samples.

### SUMMARY

Disclosed herein, in embodiments, are composite materials, comprising a population of cellulose fibers complexed with an activator, and an additive comprising synthetic fibers complexed with a tethering agent, wherein the tethering agent has an affinity for the activator, and wherein an interaction between the tethering agent and the activator attaches the synthetic fibers to the cellulose fibers to form the composite material. In embodiments, the synthetic fibers comprise microfibers. In embodiments, the activator comprises a polycation. In embodiments, the interaction between the tethering agent and the activator takes place in an aqueous medium. Also disclosed herein, in embodiments, are gypsum board composites comprising at least one layer of the composite material described herein. In embodiments, the composite material can comprise a high-value additive, which can be selected from the group consisting of a mold-resistant agent, an anti-fungal agent, a granular starch, a super-hydrophobic material, a fire-retardant, and a barrier-forming reactive emulsion.

Also disclosed herein, in embodiments, are methods for manufacturing a gypsum board composite, comprising providing a wet gypsum slurry, and flowably applying the wet gypsum slurry between two layers of facing material, wherein at least one layer of facing material comprises the composite material described above. Also disclosed herein, in embodiments, are methods for manufacturing a composite material, comprising activating a population of cellulose fibers in a first liquid medium with an activator, providing an additive comprising synthetic fibers in a second liquid medium, treating the additive with a tethering agent to form tether-bearing synthetic fibers, wherein the tethering agent is capable of interacting with the activator, adding the tether-bearing synthetic fibers to the activated population of cellulose fibers to form a composite matrix, and preparing the composite matrix to manufacture the composite material. In embodiments, the first liquid medium is an aqueous medium. In embodiments, the step of preparing the composite matrix comprises drying the composite matrix. In embodiments, the step of drying the composite matrix comprises selecting a temperature of drying that is higher than the melting point of the synthetic fibers and further comprises applying the temperature of drying to the composite matrix.

Further disclosed herein are methods for forming a gypsum board, comprising providing two sheets of a paper facing material, wherein at least one of the two sheets comprises the composite material described herein, preparing a wet slurry of gypsum, introducing the wet slurry of gypsum between the two sheets of a paper facing material so that the gypsum is contained between the two sheets, and allowing the wet slurry to set. In embodiments, the two sheets of the paper facing material are dissimilar. One of the two sheets can comprise a first composite material having a first set of properties, and the second of the two sheets can comprise a second composite material having a second set of properties. In embodiments, the step of preparing the wet slurry of gypsum can comprise adding an additive to the gypsum. The additive can be selected from the group consisting of an accelerant, a reinforcing agent, a waterproofing agent, and starch. In embodiments, the step of introducing the wet slurry can comprise pouring the wet slurry onto a first sheet of the paper facing material, and can further comprise positioning a second sheet of paper facing material onto the wet slurry before it sets. In embodiments, the method can further comprise adhering at least a portion of an edge of one sheet to at least a portion of the edge of the other sheet.

### DETAILED DESCRIPTION

Disclosed herein, in embodiments, are systems and methods for producing a material that is advantageous as a gypsum facing. In embodiments, this material can be manufactured using traditional papermaking equipment. In embodiments, this material is a cellulose-based substance that is similar to traditional paper in its physical properties. This gypsum facing material is formed, in embodiments, by adding functionalities to a paper product that adapt it for use as a building material. In embodiments, the gypsum facing material exhibits moisture resistance, mold resistance and fire resistance, while offering a smooth surface that readily accepts paint.

In an embodiment, paper-like composites can be formed using a combination of synthetic fibers and cellulosic fibers. It is recognized that synthetic fibers are difficult to attach to cellulosic fibers, owing to a lack of functional groups that would interact with those on the cellulose. Added to the wet end of the papermaking process, for example, synthetic fibers would tend to macroaggregate, so that they are not uniformly distributed within the paper web.

For gypsum board, though, synthetic fibers offer distinct advantages over natural fibers for forming the pulp-containing composite. A pulp-containing composite formed from cellulosic fibers and synthetic fibers can provide desirable features like improved strength, water resistance, mold resistance, and fire resistance, useful for drywall facing. Not to be bound by theory, it is thought that certain of these properties can be explained by increased hydrophobicity in the composite material.

These synthetic fibers should, desirably, be incorporated so that they are stably anchored to the pulp fibers, allowing them to expand or gelatinize during paper manufacturing without being dislodged. An efficient retention system that attaches the synthetic fibers to cellulose fibers durably in the wet web can advantageously enhance wet web strength during processing by allowing fiber-fiber bonding to proceed unimpeded. In embodiments, the synthetic fibers used for these applications can be microfibers. In embodiments, natural fibers (including natural microfibers) can be used to attach to cellulosic fibers, using the systems and methods disclosed herein. These systems and methods are compatible with the equipment and processes used in traditional papermaking.

As used herein, the term “microfiber” refers to synthetic or natural fiber having a smaller cross-sectional width and/or total length relative to a “larger fiber,” as utilized in the present application. In some embodiments, the microfibers have an average cross sectional width (e.g., diameter) of no more than about 100 microns. In embodiments, a microfiber may have an average cross sectional width between 0.5 and 50 microns. In other embodiments, a microfiber may have an average cross sectional width between 4 and 40 microns. In embodiments, a microfiber may have an average cross sectional width less than 30 microns. The size of the microfibers can also be characterized in terms of denier units. In some embodiments, the microfibers, on average, are less than about 10 denier, or less than about 5 denier, or less than about 2 denier, or less than about 1 denier. In embodiments, microfibers may be initially dispersed in an aqueous or solvent medium in a range of concentrations, for example ranging from solutions in which the fibers are barely wetted with the medium to solutions where the fibers are substantially diluted by the medium. In particular instances, at least some of the microfibers can include a plurality of fibrils, which can potentially be separated. The fibrils can have a nanofiber structure, e.g., exhibiting an average cross sectional width between about 1 nm and 1 micrometer, or between about 50 nm and about 500 nm. In some embodiments, the microfibers are embodied as nanofibers, which can originate from fibrils of a microfiber.

As used herein, the term “synthetic fibers” include fibers or microfibers that are manufactured in whole or in part. Synthetic fibers include artificial fibers, where a natural precursor material is modified to form a fiber. For example, cellulose (derived from natural materials) can be formed into an artificial fiber such as Rayon or Lyocell. Cellulose can also be modified to produce cellulose acetate fibers. These artificial fibers are examples of synthetic fibers.

Synthetic fibers can be formed from synthetic materials that are inorganic or organic. Synthetic inorganic fibers include mineral-based fibers such as glass fibers and metallic fibers. Glass fibers include fiberglass and various optical fibers. Metallic fibers can be deposited from brittle metals like nickel, aluminum or iron, or can be drawn or extruded from ductile metals like copper and precious metals. Organic fibers include carbon fibers and polymeric fibers. Examples of polymeric fibers include fibers made from polyamide nylon, PET or PBT polyester, polyesters, phenol-formaldehyde (PF), polyvinyl alcohol, polyvinyl chloride, polyolefins, acrylics, aromatics, polyurethanes, elastomers, and the like. A synthetic fiber may be formed from more than one natural or synthetic fiber. For example, a synthetic fiber can be a coextruded fiber, with two or more polymers forming the fiber coaxially or collinearly.

Synthetic fibers as described herein can be attached to the fibrous cellulosic matrix formed by a conventional papermaking process to form a composite facing sheet useful for drywall applications. The synthetic fibers, however, lack strong affinity to the natural and/or synthetic fibers used to form the paper web. Hence, additional steps, as disclosed herein, can be performed to attach the synthetic fibers to the fibrous web.

In embodiments, three steps can be performed to effect this attachment. In one step, the cellulosic fibers are modified by the attachment of an agent, called an “activating agent,” that prepares the surface of the cellulosic fibers for attachment to suitably modified composite synthetic fibers. In another step, the synthetic fibers are modified by attaching a tethering agent to them, where the tethering agent has a particular affinity for the activating agent attached to the paper fibers. The tether-bearing synthetic fibers are then admixed with the activated cellulosic fibers, so that the activating agent and the tethering agents interact: this interaction durably affixes the synthetic fibers bearing the tethers to the cellulosic fibers bearing the activators. In embodiments, these systems and methods can be used to treat cellulosic fibers used in papermaking with a cationic polymer of a specific molecular weight and composition as an activator, to treat an additive population such as synthetic fibers with an anionic polymer as a tethering agent, and to combine these separately-treated populations so that the synthetic fibers are attached to the pulp fibers. In embodiments, the combination of these processes can be referred to as an “Activator-Tether-Additive,” or “ATA” system.

1. Activation

As used herein, the term “activation” refers to the interaction of an activating material, such as a polymer, with the cellulosic fibers in a liquid medium, such as an aqueous solution as would be used in papermaking. An “Activator polymer” can carry out this activation. In embodiments, high molecular weight polymers can be introduced into a dispersion of cellulosic fibers to act as Activator polymers that interact, or complex, with the dispersed cellulosic fibers. The polymer-fiber complexes interact with other similar complexes, or with other fibers, and form agglomerates.

This “activation” step can function as a pretreatment to prepare the surface of the suspended substrate material (e.g., cellulosic fibers) for further interactions in the subsequent phases of the disclosed system and methods. For example, the activation step can prepare the surface of the suspended substrate materials to interact with other polymers that have been rationally designed to interact therewith in a subsequent “tethering” step, as described below. Not to be bound by theory, it is believed that when the suspended substrate materials (e.g., cellulosic fibers) are coated by an activating material such as a polymer, these coated substrate materials can adopt some of the surface properties of the activating polymer or other coating. This altered surface character in itself can be advantageous for retention, attachment and/or dewatering.

In another embodiment, activation can be accomplished by chemical modification of the suspended substrate material. For example, oxidants or bases/alkalis can increase the negative surface energy of the suspended fibers, and acids can decrease the negative surface energy or even induce a positive surface energy on suspended material. In another embodiment, electrochemical oxidation or reduction processes can be used to affect the surface charge on the suspended materials. These chemical modifications can produce activated fibrous materials that have a higher affinity for tether-bearing synthetic fibers, as described below.

Suspended substrate materials suitable for modification in accordance with these systems and methods, or activation, can include comprise materials such as lignocellulosic material, cellulosic material, minerals, vitreous material, cementitious material, carbonaceous material, plastics, elastomeric materials, and the like. In embodiments, cellulosic and lignocellulosic materials may include wood materials such as wood flakes, wood fibers, wood waste material, wood powder, lignins, wood pulp, or fibers from woody plants.

The “activation” step may be performed using flocculants or other polymeric substances. Preferably, the polymers or flocculants can be charged, including anionic or cationic polymers. In embodiments, anionic polymers can be used, including, for example, olefinic polymers, such as polymers made from polyacrylate, polymethacrylate, partially hydrolyzed polyacrylamide, and salts, esters and copolymers thereof (such as sodium acrylate/acrylamide copolymers), sulfonated polymers, such as sulfonated polystyrene, and salts, esters and copolymers thereof. Suitable polycations include: polyvinylamines, polyallylamines, polydiallyldimethylammoniums (e.g., the chloride salt), branched or linear polyethyleneimine, crosslinked amines (including epichlorohydrin/dimethylamine, and epichlorohydrin/alkylenediamines), quaternary ammonium substituted polymers, such as (acrylamide/dimethylaminoethylacrylate methyl chloride quat) copolymers and trimethylammoniummethylene-substituted polystyrene, and the like. Nonionic polymers suitable for hydrogen bonding interactions can include polyethylene oxide, polypropylene oxide, polyhydroxyethylacrylate, polyhydroxyethylmethacrylate, and the like. In embodiments, an activator such as polyethylene oxide can be used as an activator with a cationic tethering material in accordance with the description of tethering materials below. In embodiments, activator polymers with hydrophobic modifications can be used. Flocculants such as those sold under the trademark MAGNAFLOC® by Ciba Specialty Chemicals can be used.

In embodiments, activators such as polymers or copolymers containing carboxylate, sulfonate, phosphonate, or hydroxamate groups can be used. These groups can be incorporated in the polymer as manufactured, alternatively they can be produced by neutralization of the corresponding acid groups, or generated by hydrolysis of a precursor such as an ester, amide, anhydride, or nitrile group. The neutralization or hydrolysis step could be done on site prior to the point of use, or it could occur in situ in the process stream.

The activated suspended fibrous material can, in embodiments, be amine-functionalized or amine-modified. As used herein, the term “modified material” can include any material that has been modified by the attachment of one or more amine functional groups as described herein. The functional group on the surface of the suspended fibrous material can be from modification using a multifunctional coupling agent or a polymer. The multifunctional coupling agent can be an amino silane coupling agent as an example. These molecules can bond to a fibrous material's surface and then present their amine group for interaction with other fibers that have been suitably modified.

The polymer on the surface of a suspended matrix fiber can be covalently bound to the surface or interact with the surface of the fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane, for example. Polyamines include polyallyl amine, polyvinyl amine, chitosan, and polyethylenimine.

In embodiments, polyamines (polymers containing primary, secondary, tertiary, and/or quaternary amines) can also self-assemble onto the surface of the suspended matrix fibers (e.g., cellulose) to functionalize them without the need of a coupling agent. For example, polyamines can self-assemble onto the surface of the fibers through electrostatic interactions. They can also be precipitated onto the surface in the case of chitosan for example. Since chitosan is soluble in acidic aqueous conditions, it can be precipitated onto the surface of suspended material by adding a chitosan solution to the suspended material at a low pH and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the suspended matrix fibers by treating them with an acid solution to protonate the amines. In embodiments, the acid solution can be non-aqueous to prevent the polyamine from going back into solution in the case where it is not covalently attached to the fiber.

To obtain activated suspended matrix materials, the activator could be introduced into a liquid medium through several different means. For example, a large mixing tank could be used to mix an activating material with the fibers. Other mixing or dispersal processes, such as spraying, dipping, and the like, may be suitable for mixing the activating material with the fibers. The activation typically occurs rapidly, resulting in dispersed and/or agglomerated cellulosic fibers that are receptive to attachment by the tether-bearing additives, as described in more detail below.

2. Tethering

As used herein, the term “tethering” refers to an interaction between an activated suspended fiber (e.g., cellulose) and an additive synthetic fiber. The additive synthetic fiber can be treated or coated with a tethering material. The tethering material, such as a polymer, forms a complex or coating on the surface of the synthetic fibers so that they have an affinity for the activated suspended matrix material. In embodiments, the selection of tether and activator materials is intended to make the two fibrous streams complementary so that the activated matrix fibers (e.g., cellulose) in the suspension become tethered, linked or otherwise attached to the tether-bearing synthetic fibers.

In accordance with these systems and methods, the tethering material acts as a complexing agent to affix the activated fibers to the additive synthetic fibers. In embodiments, a tethering material can be any type of material that interacts strongly with the activating material and that is connectable to an additive synthetic fiber.

In embodiments, various interactions such as electrostatic, hydrogen bonding or hydrophobic behavior can be used to affix an activated complex to a tethering material that is attached to a synthetic fiber.

In embodiments, polymers such as linear or branched polyethyleneimine can be used as tethering materials. It would be understood that other anionic or cationic polymers could be used as tethering agents, for example polydiallyldimethylammonium chloride (poly(DADMAC)). In other embodiments, cationic tethering agents such as epichlorohydrin dimethylamine (epi/DMA), styrene maleic anhydride imide (SMAI), polyethylene imide (PEI), polyvinylamine, polyallylamine, amine-aldehyde condensates, poly(dimethylaminoethyl acrylate methyl chloride quaternary) polymers and the like can be used. Advantageously, cationic polymers useful as tethering agents can include quaternary ammonium or phosphonium groups. Advantageously, polymers with quaternary ammonium groups such as poly(DADMAC) or epi/DMA can be used as tethering agents. In other embodiments, polyvalent metal salts (e.g., calcium, magnesium, aluminum, iron salts, and the like) can be used as tethering agents. In other embodiments cationic surfactants such as dimethyldialkyl(C8-C22)ammonium halides, alkyl(C8-C22)trimethylammonium halides, alkyl(C8-C22)dimethylbenzylammonium halides, cetyl pyridinium chloride, fatty amines, protonated or quaternized fatty amines, fatty amides and alkyl phosphonium compounds can be used as tethering agents. In embodiments, polymers having hydrophobic modifications can be used as tethering agents.

The efficacy of a tethering material, however, can depend on the activating material. A high affinity between the tethering material and the activating material can lead to a strong and/or rapid interaction there between. A suitable choice for tethering material is one that can remain bound to the synthetic fiber's surface, but can impart surface properties that are beneficial to a strong complex formation with the activator polymer. For example, a polyanionic activator can be matched with a polycationic tether material or a polycationic activator can be matched with a polyanionic tether material. In one embodiment, a poly(sodium acrylate-co-acrylamide) activator is matched with a chitosan tether material.

In hydrogen bonding terms, a hydrogen bond donor should be used in conjunction with a hydrogen bond acceptor. In embodiments, the tether material can be complementary to the chosen activator, and both materials can possess a strong affinity to their respective deposition surfaces while retaining this surface property.

In other embodiments, cationic-anionic interactions can be arranged between activated suspended materials and tether-bearing additive fibers. The activator may be a cationic or an anionic material, as long as it has an affinity for the suspended material to which it attaches. The complementary tethering material can be selected to have affinity for the specific synthetic fibers being used in the system. In other embodiments, hydrophobic interactions can be employed in the activation-tethering system.

3. Retention and Incorporation in Papermaking

It is envisioned that the complexes formed from the additive synthetic fibers and the activated fibrous matrix can form a homogeneous part of a fibrous product like paper. In embodiments, the interactions between the activated cellulosic fibers and the tether-bearing synthetic fibers can enhance the mechanical properties of the complex that they form. For example, an activated cellulosic matrix material can be durably bound to one or more tether-bearing synthetic fibers, so that the tether-bearing synthetic fibers do not segregate or move from their position on the matrix fibers. The tethering agents on the synthetic fibers permit them to attach durably to the cellulosic matrix fibers and impart desirable properties thereto.

For papermaking, cationic and anionic polymers for activators and tethering agents (respectively) can be used. Such polymers can be selected from a wide variety of available polymers, as described above. For activating the cellulose fibers, cationic polymers can be used. The polycation can be linked to the fiber surface using a coupling agent, for example a bifunctional crosslinking agent such as a carbonyldiimidazole or a silane, or the polyamine can self-assemble onto the surface of the cellulose fiber through electrostatic, hydrogen bonding, or hydrophobic interactions. In embodiments, the polyamine can spontaneously self-assemble onto the fiber surface or it can be precipitated onto the surface. For example, in embodiments, chitosan can be precipitated on the surface of the cellulose fibers to activate them. Because chitosan is soluble only in an acidic solution, it can be added to a cellulose fiber dispersion at an acidic pH, and then can be precipitated onto the surface of the cellulose fibers by slowly adding base to the dispersion until chitosan is no longer soluble. In embodiments, a difunctional crosslinking agent can be used to attach the polycation to the fiber, by reacting with both the polycation and the fiber.

In other embodiments, a polycation, such as a polyamine, can be added directly to the cellulosic fiber dispersion or slurry. For example, the addition level of the polycation can be between about 0.01% to 5.0% (based on the weight of the cellulosic fiber), e.g., between 0.1% to 2%. For example, if the cellulose fiber population is treated with a polyamine like poly(DADMAC), a separately treated population of tether-bearing synthetic fibers can be mixed in thereafter, resulting in the attachment of the synthetic fibers to the cellulose fibers by the interaction of the activator polymer and the tether polymer. In embodiments, synthetic fibers can be treated with a variety of anionic polymers, such as anionic polyacrylamide, which then act as tethers.

For use in papermaking, larger synthetic fibers in an aqueous suspension can be broken down further with the use of shear to obtain suitable dispersions, or smaller synthetic fibers or microfibers can be added without additional mechanical processing. Tethering agents can be provided, so that an aqueous suspension of tether-bearing synthetic fibers is produced. These tether-bearing synthetic fibers can then be metered into the suspension of the matrix pulp fibers either by mixing them together in a large holding tank or using inline metering units such as suction side of fan pumps or by external pumping systems into the piping system used to convey the suspension of matrix fibers to the papermaking machine. As described above, the cellulosic matrix fibers are provided with an activating agent that mediates their interaction with the tether-bearing synthetic fibers.

Further, it would be understood by those of ordinary skill in the art that the processes and equipment for traditional papermaking can be used advantageously for manufacturing the composites disclosed herein. Aspects of traditional papermaking can be adapted advantageously for producing desirable features in these composite materials. For example, when the pulp-containing composite enters the drying phase of production, a temperature of drying can be selected that is higher than the melting point of the synthetic fibers, so that the synthetic fibers are melted as the composite dries, thereby enabling the formation of a well-bonded network of fibers that may possess advantageous properties (higher strength, moisture impermeability, hydrophobicity, and the like).

4. Use of Cellulosic-Synthetic Composites for Gypsum Board

Paper-like cellulosic-synthetic fibrous composites formed in accordance with these systems and methods can be fabricated using traditional papermaking equipment. These composite products can be designed to be similar to traditional paper in their handling and surface characteristics, while incorporating other desirable properties for building materials like moisture resistance, mold resistance and fire resistance. In embodiments, the cellulosic-synthetic composites can be used for gypsum facing materials. In embodiments, the synthetic fiber population or the cellulosic fiber population can be mixed with a small component of a high value additive such as a mold-resistant agent, an anti-fungal agent, a granular starch (for improving binding between gypsum and paper), a super-hydrophobic material, a fire retardant, a reactive emulsion which will form additional barrier layer or impart fire retardancy upon papermaking and drying, and the like, where the high-value additive becomes incorporated or agglomerated within the designated population by the activation or tethering process, as applicable.

Use of these cellulosic-synthetic paper-like composites is consistent with the typical steps for producing gypsum board. In an embodiment, for example, a wet slurry of gypsum can be flowably applied between two layers of facing material, where one of the layers comprises a paper-like composite material formed in accordance with these systems and methods. For example, the wet slurry of gypsum can be poured onto a conveyor between two layers of the paper-like composites formed in accordance with these systems and methods, so that the paper-like composites contain the slurry and allow it to set. The wet gypsum slurry can be generated by a mechanical mixer that combines water with a mineral substrate comprising anhydrous calcium sulfate and/or calcium sulfate hemihydrate, along with various additives like accelerants, reinforcing agents or waterproofing. Starch is an additional additive that may be added to the slurry to improve its attachment to the paper-like composite layers within which it is deposited. Starch granules can be added to either the cellulosic suspension, where the granules attach to cellulosic fibers via the activator or to the synthetic fibers, where the granules are agglomerated with the fibers with the help of the tethering polymer. The slurry can be deposited on a continuously advancing lower facing sheet of the paper-like composite material prepared in accordance with these systems and methods, while a continuously advancing upper facing sheet of similar material is laid on top of the slurry. In embodiments, a gypsum board can be prepared where the paper facing on one side has different properties than the paper facing on the other side. For example, a paper facing with mold resistance or water resistance may be more desirable for an outer-facing surface of a gypsum board, while a less modified internal surface may be desirable so that it holds paint and offers a more aesthetic finish to the gypsum board. The edges of the paper-like composite facing sheets can be attached to each other with a suitable adhesive. The facing sheets and gypsum slurry can be passed through upper and lower rollers or forming plates, producing a flat strip of unset gypsum sandwiched between the facing sheets. During this process, the core can begin to hydrate, or “set.” Once the gypsum core has set sufficiently, the strip can be cut into shorter lengths suitable for construction use. After they are cut, the gypsum boards can be dried in ovens to evaporate any residual water.

### EXAMPLES

### Materials

Market softwood and hardwood pulp
Recycled brown pulp
Poly(diallyldimethylammonium chloride), Hi Molecular Weight, 20 wt % in water (polyDADMAC), Sigma-Aldrich, St. Louis, Mo.
MagnaFloc 919, Ciba Specialty Chemicals Corporation, Suffolk, Va.
ChitoClear Chitosan CG-10, Primex, Siglufjordur, Iceland
Polyethylene fibers PEFYB-00620, MiniFibers, Inc., Johnson City, Tenn.
Modified Polyethylene fibers PEFYB-ONL490, MiniFibers, Inc., Johnson City, Tenn.
Polypropylene fibers (“PP”), PEFYB-00Y600, MiniFibers, Inc., Johnson City, Tenn.
PES/Nylon pie wedge bicomponent cut fibers

### Example 1

### Control Virgin Pulp

A 0.5% slurry was prepared by blending 3.5% by weight softwood and hardwood pulp mixture (in the ratio of 20:80) in water.

### Example 2

### Control Recycled Pulp

A 0.5% slurry was prepared by blending 22.5% recycled brown pulp in water.

### Example 3

### Handsheet Preparation

Handsheets were prepared using a Mark V Dynamic Paper Chemistry Jar and Hand-Sheet Mold from Paper Chemistry Laboratory, Inc. (Larchmont, N.Y.). Handsheets were prepared without addition of polymers as controls, using the pulps prepared as described in Example 1 and 2. Handsheets were prepared with the addition of polymers as experimental samples, as described below.

For preparing each experimental handsheet, the appropriate volume of 0.5% pulp slurry prepared in accordance with Examples 1 or 2 (as applicable) was activated with up to 2% of the selected polymer(s) (based on dry weight), as described below in more detail. Polymer additions were performed at 5 minute intervals. This polymer-containing slurry was diluted with up to 3 L of water and added to the handsheet maker, where it was mixed at a rate of 1100 RPM for 5 seconds, 700 RPM for 5 seconds, and 400 RPM for 5 seconds. The water was then drained off. The subsequent sheet was then transferred off of the wire, pressed and dried.

For preparing sheets containing low melting point synthetic fibers PEFYB-00620, PEFYB-0NL490, PEFYB-00Y600, as described below in Example 6, the sheets were dried as described above and then heated further to ensure melting of the synthetic fibers.

### Example 4

### Tensile Test

Tensile tests were conducted on control and experimental samples using an Instron 3343. Samples of handsheets for tensile testing were initially cut into 1 inch (in) wide strips with a paper cutter, and then attached within the Instron 3343. The gauge length region was set at 4 in and the crosshead speed was 1 in/minute. Thickness was measured to provide stress data as was the weight to be able to normalize the data by weight of samples. The strips were tested to failure with an appropriate load cell. At least three strips from each control or experimental handsheet sample were tested and the values were averaged together.

### Example 5

### Preparation of Synthetic Fibers with and without Tether

PEFYB-00620, PEFYB-0NL490, PEFYB-00Y600, and PES/Nylon Bicomponent Fibers (and mixtures of two or more of the previous) were dispersed in water in slurry form such that the solids content was about 20%. In samples containing a tether, MagnaFloc 919 was then added 0.1% by weight as a tethering agent.

### Example 6

### Process for Preparing Handsheets from Activated Pulp and Tethered Synthetic Fibers

800 mL of a 0.5% pulp slurry prepared in accordance with Example 1 or 2 (as applicable) was initially provided. The pulp slurry was activated with 0.1% by fiber weight polyDADMAC. Separately, synthetic fibers and tethered synthetic fibers were prepared as a slurry in accordance with Example 5. Each slurry was mixed for 5 minutes and then combined and mixed for another 5 minutes using an overhead stirrer. Handsheets were then produced by the method in Example 3. The final basis weight was approximately 80 gsm for these handsheets.

### Example 7

### Preparation Of Chitosan Solution

CG-10 was added to water to make a 1% by weight slurry of chitosan (note that the CG-10 in water forms an aqueous suspension, but it dissolves with acidification to form a solution). Strong acid was added dropwise to the slurry with stirring until the solution reached a pH of 2.5 and the chitosan was dissolved.

### Example 8

### Preparation of Coated Synthetic Fibers with Chitosan

PEFYB-00620, PEFYB-0NL490, PEFYB-00Y600, and PES/Nylon Bicomponent Fibers (and mixtures of two or more of the previous) were dispersed in water in slurry form such that the solids content was about 20%. A strong acid was then added to the slurry to bring the pH below 2.5. The solution in Example 7 was added to the synthetic fiber slurry so that the chitosan was 1% by weight of the synthetic fibers. The pH was then raised back to 8-9 with a strong base to precipitate any unbound chitosan.

### Example 9

### Process for Preparing Handsheets from Pulp and Chitosan-Coated Synthetic Fibers

800 mL of a 0.5% pulp slurry prepared in accordance with Example 1 or 2 (as applicable) was initially provided. Separately, tethered synthetic fibers were prepared as a slurry in accordance with Example 8. Each slurry was mixed for 5 minutes and then combined and mixed for another 5 minutes using an overhead stirrer. Handsheets were then produced by the method in Example 3. The final basis weight was approximately 80 gsm for these handsheets.

### Example 10

### The Effect of Tethered Synthetic Fibers on Strength and Hydrophobicity

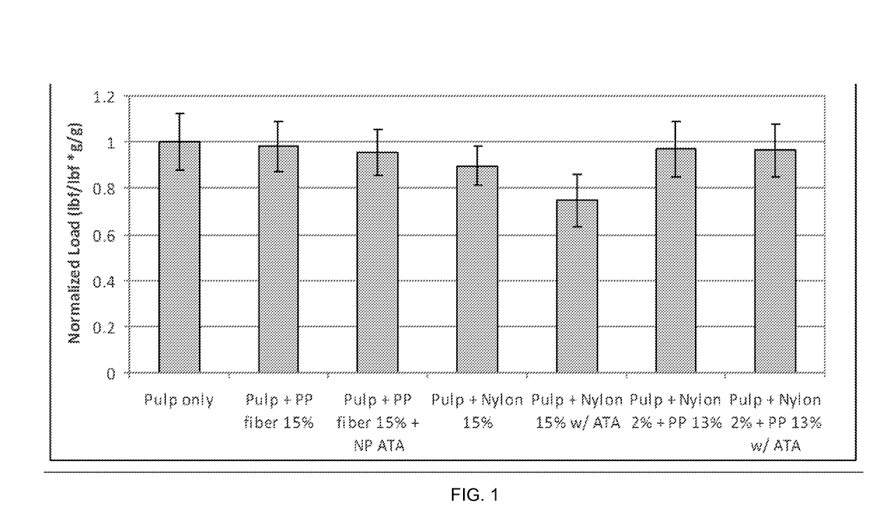

Samples were prepared as in Example 6, where the amount of tether-bearing synthetic fibers were a total of 15% of the solids weight. The tether-bearing synthetic fibers had been prepared in accordance with Example 5. Samples were made both with activator and tether and without either activator or tether. For samples treated with the Activator-Tether-Additive (“ATA”) process, the tether used on the synthetic fibers was 0.1% MagnaFloc 919 by solids and the activator on the pulp was 0.1% polyDADMAC by solids. The max load for each sample was measured using an Instron as in Example 4. Data were normalized by the mass to show load contribution per overall solids weight. The graph shown in FIG. 1 shows the strength data with all of the aforementioned conditions mentioned in this example. This graph shows normalized maximum load for samples with and without synthetic fibers, with and without the use of the Activator-Tether-Additive (“ATA”) technology.

The hydrophobicity improvement with the samples above was also examined. Using recycled fiber handsheet samples prepared as in Examples 3 and 6, hydrophobicity was tested by depositing a 25 microliter water droplet on the surface of the paper and recording the time for the droplet to completely be absorbed by the paper. The results of the hydrophobicity tests are shown in Table 1, showing normalized water droplet holdout times for pulp samples with and without use of ATA. These results demonstrate that the use of certain synthetic fibers in combination with pulp fibers improves the water resistance of the paper by up to 26,600% compared to control samples having no added synthetic fibers.

TABLE 1
Hydrophobicity (Water Droplet Holdout)

| | | water | |
|---|---|---|---|
| | | holdout | |
| condition | Description | Seconds (s) | Notes |
| 1 | Pulp only | 27 | |
| 2 | Pulp + PP fiber 15% | 697 | |
| 3 | Pulp + PP fiber 15% + NP | >7200 | droplet still |
| | ATA | | remains at |
| | | | 2 hours |
| 4 | Pulp + Nylon 15% | 10 | |
| 5 | Pulp + Nylon 15% w/ATA | 30 | |
| 6 | Pulp + Nylon 2% + PP 13% | 7200 | |
| 7 | Pulp + Nylon 2% + PP 13% | 7200 | |
| | w/ATA | | |

### Example 11

### The Effect of Chitosan-Coated Synthetic Fibers on Strength and Hydrophobicity

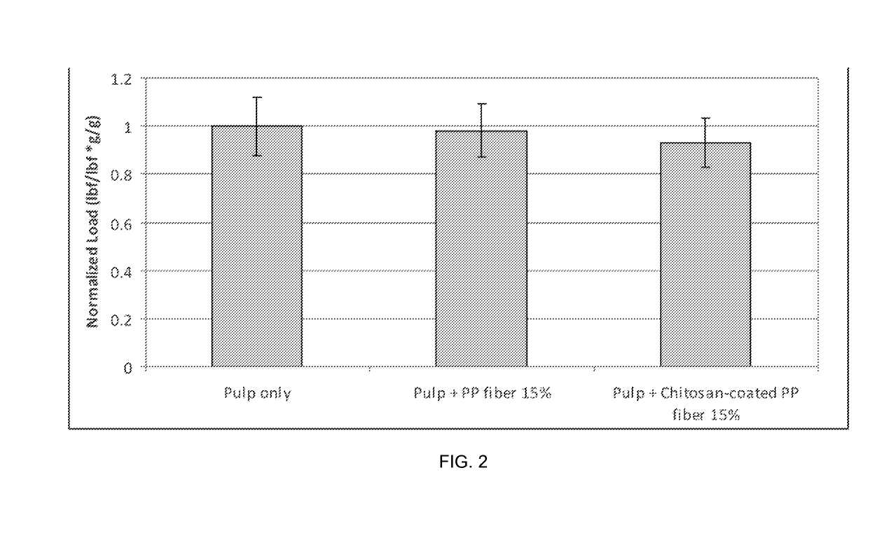

Samples were prepared as in Example 9, where the amount of chitosan-coated synthetic fibers were a total of 15% of the solids weight. The chitosan-coated synthetic fibers had been prepared in accordance with Example 8. The max load for each sample was measured using an Instron as in Example 4. Data were normalized by the mass to show load contribution per overall solids weight. The graph shown in FIG. 2 shows the strength data with all of the aforementioned conditions mentioned in this example. The graph presents normalized maximum load for pulp with synthetic fibers with and without the use of chitosan.

The hydrophobicity improvement with the samples above was also examined. Using recycled fiber handsheet samples prepared as in Example 9, hydrophobicity was tested by depositing a 25 microliter water droplet on the surface of the paper and recording the time for the droplet to completely be absorbed by the paper. The results of the hydrophobicity tests are shown in Table 2. These results, examining the effect on hydrophobicity of using pulp with and without synthetic fibers and with and without chitosan, demonstrate that the use of chitosan-coated synthetic fibers improves the water resistance of the paper by up to 26,600% compared to control samples having no synthetic fibers.

TABLE 2
Hydrophobicity (Water Droplet Holdout)

| | | water | |
|---|---|---|---|
| | | holdout | |
| condition | Description | (s) | Notes |
| 1 | Pulp only | 27 | |
| 2 | Pulp + PP fiber 15% | 697 | |
| 3 | Pulp + Chitosan-coated PP fiber 15% | >7200 | droplet still |
| | | | remains at |
| | | | 2 hours |

### EQUIVALENTS

While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

What is claimed:

1. A composite material, comprising:
a population of cellulose fibers complexed with an activator, and
an additive comprising synthetic fibers complexed with a tethering agent,
wherein the tethering agent has an affinity for the activator, and wherein an interaction between the tethering agent and the activator attaches the synthetic fibers to the cellulose fibers to form the composite material.

2. The composite material of claim 1, wherein the synthetic fibers comprise microfibers.

3. The composite material of claim 1, wherein the activator comprises a polycation.

4. The composite material of claim 1, wherein the interaction between the tethering agent and the activator takes place in an aqueous medium.

5. The composite material of claim 1, further comprising a high-value additive.

6. The composite material of claim 5, wherein the high-value additive is selected from the group consisting of a mold-resistant agent, an anti-fungal agent, a granular starch, a super-hydrophobic material, a fire-retardant, and a barrier-forming reactive emulsion.

7. A gypsum board composite comprising at least one layer of the composite material of claim 1.

8. A method for manufacturing a gypsum board composite, comprising:
providing a wet gypsum slurry, and
flowably applying the wet gypsum slurry between two layers of facing material, wherein at least one layer of facing material comprises the composite material of claim 1.

9. A method for manufacturing a composite material, comprising:
activating a population of cellulose fibers in a first liquid medium with an activator,
providing an additive comprising synthetic fibers in a second liquid medium,
treating the additive with a tethering agent to form tether-bearing synthetic fibers, wherein the tethering agent is capable of interacting with the activator,
adding the tether-bearing synthetic fibers to the activated population of cellulose fibers to form a composite matrix, and
preparing the composite matrix to manufacture the composite material.

10. The method of claim 9, wherein the first liquid medium is an aqueous medium.

11. The method of claim 9, wherein the step of preparing the composite matrix comprises drying the composite matrix.

12. The method of claim 11, where the step of drying the composite matrix comprises selecting a temperature of drying that is higher than the melting point of the synthetic fibers and further comprises applying the temperature of drying to the composite matrix.

13. A method of forming a gypsum board, comprising:
providing two sheets of a paper facing material, wherein at least one of the two sheets comprises the composite material of claim 1,
preparing a wet slurry of gypsum,
introducing the wet slurry of gypsum between the two sheets of a paper facing material so that the gypsum is contained between the two sheets, and
allowing the wet slurry to set.

14. The method of claim 13, wherein the two sheets are dissimilar.

15. The method of claim 14, wherein one of the two sheets comprises a first composite material of claim 1 having a first set of properties, and the second of the two sheets comprises a second composite material of claim 1 having a second set of properties.

16. The method of claim 13, wherein the step of preparing the wet slurry of gypsum further comprises adding an additive to the gypsum.

17. The method of claim 16, wherein the additive is selected from the group consisting of an accelerant, a reinforcing agent, a waterproofing agent, and starch.

18. The method of claim 13, wherein the step of introducing the wet slurry comprises pouring the wet slurry onto a first sheet of the paper facing material.

19. The method of claim 18, further comprising positioning a second sheet of the paper facing material onto the wet slurry before it sets.

20. The method of claim 13, further comprising adhering at least a portion of an edge of one sheet to at least a portion of the edge of the other sheet.
